(19) United States
(12) Patent Application Publication
(10) Pub. No.: US 2009/0289903 A1
(43) Pub. Date: Nov. 26, 2009

(54) CONTROL METHOD FOR DISPLAYING ICONS ON A TOUCHSCREEN

(75) Inventors: CHUN-LIN CHEN, Tu-Cheng (TW); YI-KAI LIN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/195,388

(22) Filed: Aug. 20, 2008

(30) Foreign Application Priority Data
May 21, 2008 (CN) 200810301699.X

(51) Int. Cl. G06F 3/041

(52) U.S. Cl. 345/173; 715/835

(57) ABSTRACT

A control method for displaying icons of a touchscreen is shown. The touchscreen includes an icon control region and an icon display region comprising a plurality of icon display grids. The method includes sensing a touch on the icon control region and determining if a touch distance exceeds a predetermined distance. Each icon in the icon display region may be moved to the next icon display grid according to the move orientation of the finger of the user if the touch distance is less than the predetermined distance. Moving each icon in the icon display region moves two or more icon display grids according to the move orientation of the finger of the user if the distance is greater than the predetermined distance.

### BACKGROUND

1. Field of the Invention

Embodiments of the present disclosure relate to control methods for displaying icons, and particularly to a control method for displaying icons on a touchscreen.

2. Description of Related Art

Touchscreen displays have been utilized in various portable consumer electronics, such as cellular telephones and personal digital assistants (PDA). In these touchscreen displays, icons and characters are displayed on the display apparatus. However, touchscreen displays for portable devices are relatively small. As a result, the icons within the touchscreen application cannot be entirely displayed on the touchscreen display of a portable device, thereby making it inconvenient and time-consuming for a user to search for icons.

What is needed, therefore, is a control method for displaying icons within a touchscreen display which can solve the above problem.

### BRIEF DESCRIPTION OF THE DRAWINGS

FIG. 1 is a schematic diagram of a touchscreen for displaying icons in accordance with an exemplary embodiment of the present disclosure;

FIG. 2 is a block diagram of a system for selecting and displaying icons on the touchscreen of FIG. 1.

FIG. 3 is a flowchart of an exemplary control method for displaying icons on the touchscreen of FIG. 1.

### DETAILED DESCRIPTION

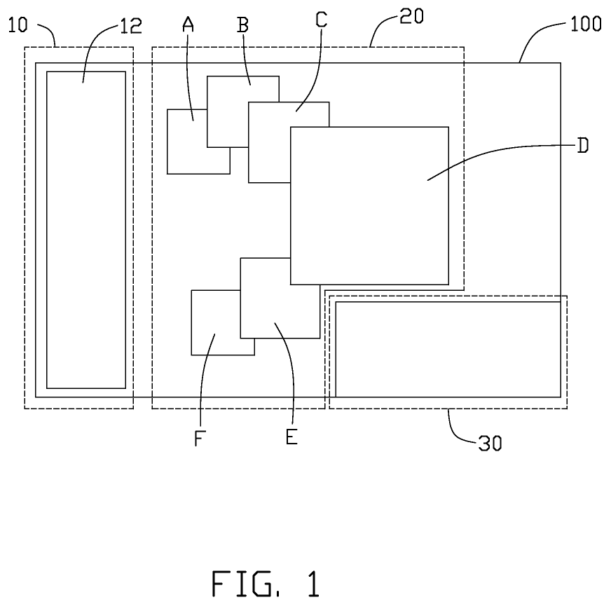

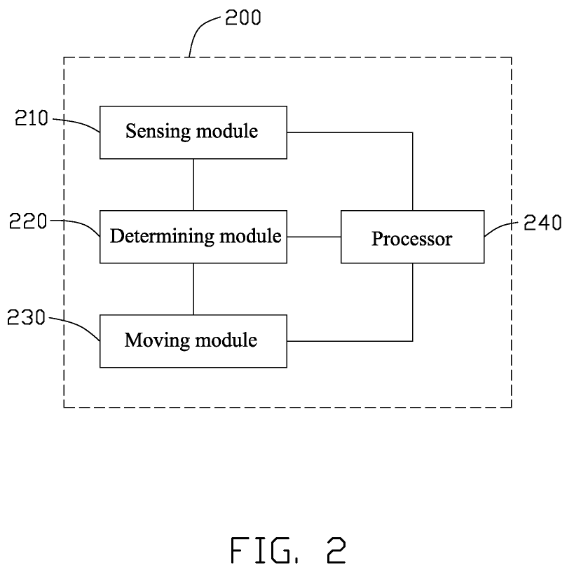

FIGS. 1 and 2 illustrate a touchscreen 100 displaying icons according to one embodiment of the present disclosure. In one embodiment, the touchscreen 100 includes an icon control region 10, a control unit 12, an icon display region 20, and an icon explaining region 30. The regions 10, 20, 30 and the control unit 12 may be selected by a user of the touchscreen 100 to execute one or more computerized operations of a device employing the touchscreen 100.

In one embodiment, the control unit 12 may be positioned on the left side of the touchscreen 100. The control unit 12 is configured for displaying one or more icons indicative of control operations of an icon. The icon display region 20, in one embodiment may be positioned in the center of the touchscreen 100 and includes a plurality of icons A, B, C, D, E, F, etc. FIG. 1 illustrates six icons in the icon display region 20, but in other embodiments, more or less icons may be displayed in the icon display region 20. In one embodiment, the icons A, B, C, D, E, F may be positioned in the center of the touchscreen 100 in an annular ring. The icon explaining region 30 may be positioned on the right side of the touchscreen 100, in one embodiment.

In operation, users may select an icon from the icon display region 20 by touching the control unit 12 with a finger or a stylus, for example. The selected icon is enlarged and displayed overlapping one or more icons in the icon display region 20. For example, icon D has been selected and enlarged as shown in FIG. 2. Because icon D has been enlarged and overlaps the other icons A, B, C, E, F on the touchscreen 100, icons A, B, C, E, F are displayed behind icon D. In one embodiment, an icon display grid represents a location of an icon in the icon display region 20. Namely, the icons A, B, C, D, E, F are each displayed on a corresponding icon display grid. The icon display grid of icon D represents a selected location that a user has touched. The icon explaining region 30 displays the function of the selected icon D. For example, the function of icon D may be displayed as “GPS Signal Viewer”. The menu function of the selected icon can be activated by clicking the selected icon.

In one embodiment, a user may touch the control unit 12 using an up-to-down orientation or a down-to-up orientation with a finger to control the icons A, B, C, D, E, F to move one or more icon display grids clockwise or counter-clockwise. The locations or shapes of the icon control region 10, the icon display region 20, and the icon explaining region 30 can be designed according to user-specific needs.

FIG. 2 is a block diagram of a system 200 for selecting and displaying icons on the touchscreen 100. The system 200 may be used to select and display icons on the touchscreen 100 upon selection of an icon by a user of the system 200. In one embodiment, the system 200 includes a sensing module 210, a determining module 220, a moving module 230, and a processor 240. The modules 210, 220, 230 may be used to execute one or more operations of the touchscreen 100.

The sensing module 210 is configured for sensing a touch on the control unit 12. Sensing the touch, in one embodiment, may comprise sensing resistive and/or capacitive differences in a finger and/or stylus, for example. If a selected icon displayed on the icon display unit 20 is no longer needed, the user can touch the control unit 12 using an up-to-down orientation or a down-to-up orientation to control the icons A, B, C, D, E, F to move one or more icon display grids clockwise or counter-clockwise.

The determining module 220 is configured for determining if a touch distance on the control unit 12 exceeds a predetermined distance, such as 100 pixels in one embodiment.

The moving module 230 is configured for moving icons in the icon display region 20 and/or move one or more icon display grids clockwise or counter-clockwise. If the touch distance is less than the predetermined distance, the moving module 230 move icons A, B, C, D, E, F in the icon display region 20 to next icon display grid according to a move orientation of the finger of the user. If the touch distance is greater than the predetermined distance, the moving module 230 move icons A, B, C, D, E, F in the icon display region 20 to two or more icon display grids according to a move orientation of the finger of the user.

One or more specialized or general purpose processors, such as the processor 240 may be used to execute the sensing module 210, the determining module 220, and the moving module 230.

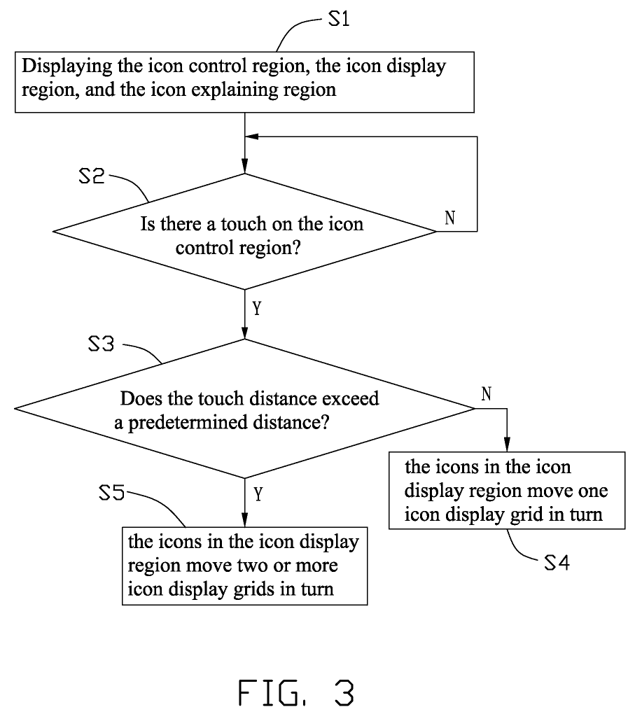

FIG. 3 is a flowchart of one embodiment of a method for selecting and displaying icons on the touchscreen 100. The method of FIG. 2 may be used to select an icon on a touchscreen device so as to locate a contact's phone number, for example. Depending on the embodiment, additional blocks may be added, others deleted, and the ordering of the blocks may be changed.

In block S1, the touchscreen 100 may be turned on so as to display the control unit 12 and the icons A, B, C, D, E, F on the touchscreen 100. A predetermined icon is selected and enlarged and displayed in the icon display region 20. Accordingly, the icon explaining region 30 displays the function of the selected icon on the touchscreen 100.

In block S2, the sensing module 210 senses a touch on the control unit 12. The touch on the control unit 12 corresponds to a touch distance. If the selected icon is no longer needed, the user can touch the control unit 12 through an up-to-down orientation or a down-to-up orientation to control the icons A, B, C, D, E, F to move one or more icon display grids clockwise or counter-clockwise.

In block S3, the determining module 220 determines if the touch distance exceeds a predetermined distance, such as 100 pixels. If a touch distance on the control unit 12 exceeds the predetermined distance, the moving module 230 may move the icons A, B, C, D, E, F and/or move one or more icon display grids clockwise or counter-clockwise

In block S4, the moving module 230 moves the icons A, B, C, D, E, F in the icon display region to an icon display grid according to the move orientation of the finger of the user if the touch distance is less than the predetermined distance. Specifically, each icon (such as A, B, C, D, E, F) moves from the current icon display grid to the next icon display grid. If the icons A, B, C, D, E, F move clockwise, icon D is moved from the selected location to the first icon display grid behind the lower-left corner of the selected location. Accordingly, icon C is moved from the first icon display grid behind the upper-left corner of the selected location to the selected location, and the icon C is enlarged and displayed in the icon display region 20. Accordingly, the icon explaining region 30 displays the function of icon C.

In block S5, the moving module 230 moves the icons A, B, C, D, E, F in the icon display region 20 and/or moves more than one icon display grids according to a move orientation of the finger of the user if the touch distance is greater than the predetermined distance. If the icons A, B, C, D, E, F move two icon display grids clockwise, for example, icon D is moved from the current location to the second icon display grid behind the lower-left of the selected location. Accordingly, icon B is moved from the second icon display grid behind the upper-left of the selected location to the selected location, and the icon B is enlarged and displayed in the icon display region 20. Accordingly, the icon explaining region 30 displays the function of icon B.

The icons A, B, C, D, E, F are positioned in the center of the touchscreen 100 in an annular ring. The user can touch the icon control region 10 through an up-to-down orientation or a down-to-up orientation to select an icon. Therefore, the control method for displaying icons within a touchscreen allows the user to conveniently search for icons.

A selected icon can be displayed on the icon display region 20 in other modes according to user-specific needs. For example, the color of the selected icon can be configured to be different from the other icons. If desired, the function of the icons within the touchscreen 100 can be omitted from being displayed in the icon explaining region 30.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A control method for displaying icons on a touchscreen, the method comprising:
displaying an icon control region and a icon display region on the touchscreen, wherein the icon display region comprises a plurality of icon display grids, each display grid displaying a selecting location for displaying a selected icon;
sensing a touch on the icon control region according to a move orientation of a finger of a user, wherein the move orientation corresponds to a touch distance;
determining if the touch distance exceeds a predetermined distance;
moving each icon in the icon display region to a next icon display grid according to the move orientation of the finger of the user upon a condition that the touch distance is less than the predetermined distance; and
moving each icon in the icon display region to two or more icon display grids according to the move orientation of the finger of the user upon a condition that the touch distance is greater than the predetermined distance.

2. The control method as claimed in claim 1, wherein the touchscreen further comprises an icon explaining region, the icon explaining region displaying a function of the selected icon.

3. The control method as claimed in claim 2, wherein the icon control region is positioned on the left side of the touchscreen, the icon display region is positioned in the center of the touchscreen, the icon explaining region is positioned on the right side of the touchscreen.

4. The control method as claimed in claim 1, wherein the icons of the icon display region are positioned on the icon display region in an annular ring.

5. The control method as claimed in claim 1, an up-to-down orientation or a down-to-up orientation controls the icons of the icon display region to move clockwise or counter-clockwise.

6. The control method as claimed in claim 1, wherein the predetermined distance is 100 pixels.

7. The control method as claimed in claim 1, wherein the selected icon is enlarged in the selecting location of the icon display region.

8. The control method as claimed in claim 11, wherein the selected icon is set to overlap other icons of the icon display region.
